(19) United States
(12) Patent Application Publication
(10) Pub. No.: US 2015/0092679 A1
(43) Pub. Date: Apr. 2, 2015

(54) Enhancement of the Implementation of the High Speed Cell FACH/RACH Feature

(71) Applicant: Nokia Solutions and Networks Oy, Espoo (FI)

(72) Inventor: Khalil Mouzawak, Paris (FR)

(73) Assignee: Nokia Solutions and Networks Oy, Espoo (FI)

(21) Appl. No.: 14/053,849

(22) Filed: Oct. 15, 2013

Related U.S. Application Data
(60) Provisional application No. 61/885,232, filed on Oct. 1, 2013.

(51) Int. Cl. H04W 72/12

(52) U.S. Cl. CPC H04W 72/1231
USPC 370/329

(57) ABSTRACT

A method includes adapting a high speed Cell_FACH feature to a load of a cell. The adapting is performed at least by changing a value of a data volume threshold so delay experienced by a user equipment in a Cell_FACH state is kept lower than a delay the user equipment would experience if moved to a Cell_DCH state. The value of the data volume threshold determines a data volume that, if not exceeded, causes a user equipment to be kept in the Cell_FACH state. The method includes deciding for each user equipment in the Cell_FACh state whether to keep the user equipment in the Cell_FACH state or move the user equipment to the Cell_DCH state. The deciding for each user equipment is based at least on the changed value for the data volume threshold and a data volume for the user equipment. Apparatus and computer program products are also disclosed.

### CROSS-REFERENCE TO RELATED APPLICATIONS

The present application claims the benefit under 35 U.S.C. §119(e) of U.S. Provisional Patent Application No. 61/885,232, filed on Oct. 1, 2013, the disclosure of which is hereby incorporated by reference in its entirety.

### TECHNICAL FIELD

This invention relates generally to WCDMA/HSPA systems and, more specifically, relates to packet data transfer in such systems.

### BACKGROUND

This section is intended to provide a background or context to the invention disclosed below. The description herein may include concepts that could be pursued, but are not necessarily ones that have been previously conceived, implemented or described. Therefore, unless otherwise explicitly indicated herein, what is described in this section is not prior art to the description in this application and is not admitted to be prior art by inclusion in this section. Abbreviations that may be found in the specification and/or the drawing figures are defined at the end of this document.

A WCDMA/HSPA terminal can be in two different modes. For instance, the terminal is in Idle mode when there are no radio resources allocated to the terminal. In this case, the radio network is not aware of the terminal. The terminal is in Connected mode when the radio network is aware of the terminal location and some resources are assigned to the terminal. In the Connected mode, the terminal can be in four different states as indicated in FIG. 1.

In the Cell_DCH state, the terminal has dedicated resources, and in this state the terminal can use the high speed shared channel. The highest data rates can be reached in this state. When the terminal has no more data to send or receive and after expiration of an activity timer, the terminal is moved to the Cell_FACH state.

Up to 3GPP release 6, the terminal could send small amount of data in the Cell_FACH state. When inactivity is long (e.g., based on expiration of an activity timer), the terminal is moved to the Cell_PCH or URA_PCH state. The benefit of Cell_FACH, Cell_PCH and URA_PCH states for the terminal is low battery consumption, as the terminal in those states monitors a limited number of radio channels.

The introduction of High Speed (HS) Cell_FACH feature in 3GPP release 7 for downlink and release 8 for the uplink allows the use of high speed channels in Cell_FACH state too. The High Speed Cell_FACH feature is also referred as the Enhanced Cell_FACH, the Enhanced FACH, the Enhanced RACH, or the HS_FACH. A HS_FACH user equipment is a 3G terminal equipment that supports the HS_FACH feature.

The benefits of this new feature include the following:
Improvement of the quality of experience of the users, as access to data is faster; and
Support of more users in the Cell_FACH state, which reduces the signaling load on the RNC.

Without the feature, a terminal in a dormant Cell_PCH state needs to move to the Cell_DCH state before receiving or transmitting data, and for this transition a lot of signaling messages are exchanged between the terminal and the radio network (e.g., NodeB/RNC), this can take up to 600 ms.

With the HS_FACH feature, the terminal is moved from the Cell_PCH state to the Cell_FACH state, where the terminal can start using high speed data. Fewer signaling messages are needed for this transition and this transition takes about 150 ms.

FIG. 2 shows a delay before data transmission in case of a UE transition from the Cell_PCH state to the Cell_DCH state and in case of a transition from the Cell_PCH state to the Cell_FACH state for only one UE in a cell. Because of less signaling needed when terminals are kept longer in the Cell_FACH state, the new feature reduces significantly the signaling load of the RNC.

However, improvements in use of this feature could be made.

### SUMMARY

This section is intended to provide examples and is not meant to be limiting.

In an example, a method includes adapting a high speed Cell_FACH feature to a load of a cell. The adapting is performed at least by changing a value of a data volume threshold corresponding to HS_FACH user equipment so delay experienced by a user equipment in a Cell_FACH state is kept lower than a delay the user equipment would experience if moved to a Cell_DCH state. The value of the data volume threshold determines a data volume that, if not exceeded, causes a user equipment to be kept in the Cell_FACH state. The method includes deciding for each user equipment in the Cell_FACh state whether to keep the user equipment in the Cell_FACH state or move the user equipment to the Cell_DCH state. The deciding for each user equipment is based at least on the changed value for the data volume threshold and a data volume for the user equipment.

Another exemplary embodiment is an exemplary apparatus that includes one or more processors and one or more memories including computer program code. The one or more memories and the computer program code are configured to, with the one or more processors, cause the apparatus to perform at least the following: adapting a high speed Cell_FACH feature to a load of a cell, the adapting performed at least by changing a value of a data volume threshold corresponding to HS_FACH user equipment so delay experienced by a user equipment in a Cell_FACH state is kept lower than a delay the user equipment would experience if moved to a Cell_DCH state, where the value of the data volume threshold determines a data volume that, if not exceeded, causes a user equipment to be kept in the Cell_FACH state; and deciding for each user equipment in the Cell_FACh state whether to keep the user equipment in the Cell_FACH state or move the user equipment to the Cell_DCH state, the deciding for each user equipment based at least on the changed value for the data volume threshold and a data volume for the user equipment.

A further exemplary embodiment is an exemplary computer program product that includes a computer-readable storage medium bearing computer program code embodied therein for use with a computer. The computer program code includes: code for adapting a high speed Cell_FACH feature to a load of a cell, the adapting performed at least by changing a value of a data volume threshold corresponding to HS_FACH user equipment so delay experienced by a user equipment in a Cell_FACH state is kept lower than a delay the user equipment would experience if moved to a Cell_DCH state, where the value of the data volume threshold determines a data volume that, if not exceeded, causes a user equipment to be kept in the Cell_FACH state; and code for deciding for each user equipment in the Cell_FACh state whether to keep the user equipment in the Cell_FACH state or move the user equipment to the Cell_DCH state, the deciding for each user equipment based at least on the changed value for the data volume threshold and a data volume for the user equipment.

### BRIEF DESCRIPTION OF THE DRAWINGS

In the attached Drawing Figures:

FIG. 1 is a block diagram of terminal modes and states for a WCDMA/HSPA terminal;

FIG. 2 illustrates fast access to data transmission for terminals moving from the Cell_PCH state to the Cell_FACH state when the HS_FACH feature is activated;

FIG. 3 is a block diagram of an exemplary system in which the exemplary embodiments may be practiced;

FIG. 4 illustrates access to data transmission for HS_FACH UEs delayed by load in the Cell_DCH state;

FIG. 5 is a table used to illustrate transmission delay with different thresholds;

FIG. 6 is a table used to illustrate change of HS_FACH threshold value as a function of number of users in the Cell_FACH state;

FIG. 7 is a signaling diagram of a common measurement initiation procedure, successful operation, and is reproduced from 3GPP TS 25.433;

FIG. 8 is a signaling diagram of a common measurement report procedure, and is reproduced from 3GPP TS 25.433;

FIGS. 9-15 provide illustrations of threshold change over time; and

FIG. 16 is a logic flow diagram for enhancement of the Implementation of the high speed cell FACH/RACH feature, and illustrates the operation of an exemplary method, a result of execution of computer program instructions embodied on a computer readable memory, and/or functions performed by logic implemented in hardware, in accordance with an exemplary embodiment.

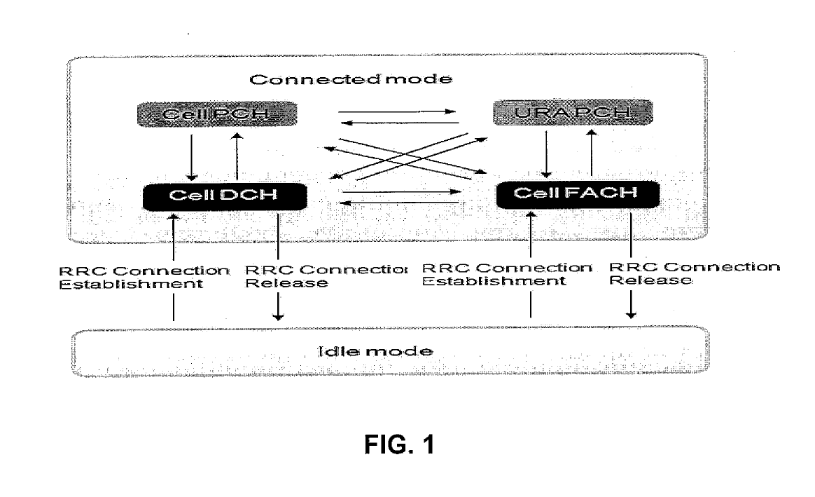

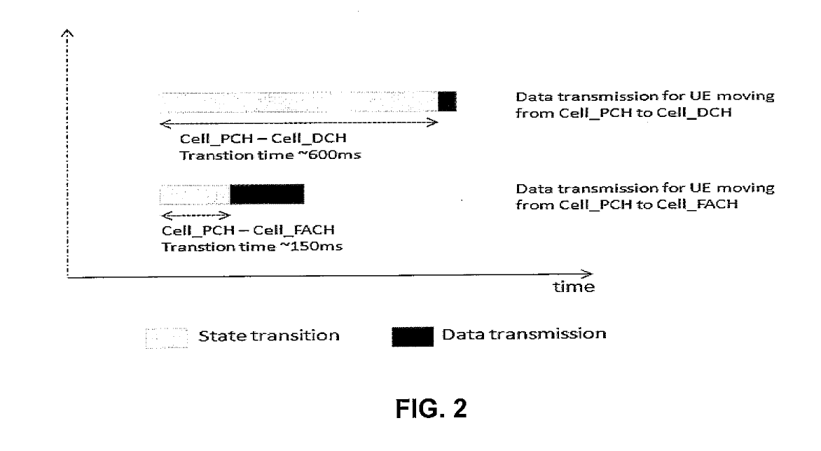

### DETAILED DESCRIPTION OF THE DRAWINGS

The exemplary embodiments herein describe enhancement of the implementation of the high speed cell FACH/RACH feature. Additional description of exemplary embodiments for the enhancement is presented after a system into which the exemplary embodiments may be used is described.

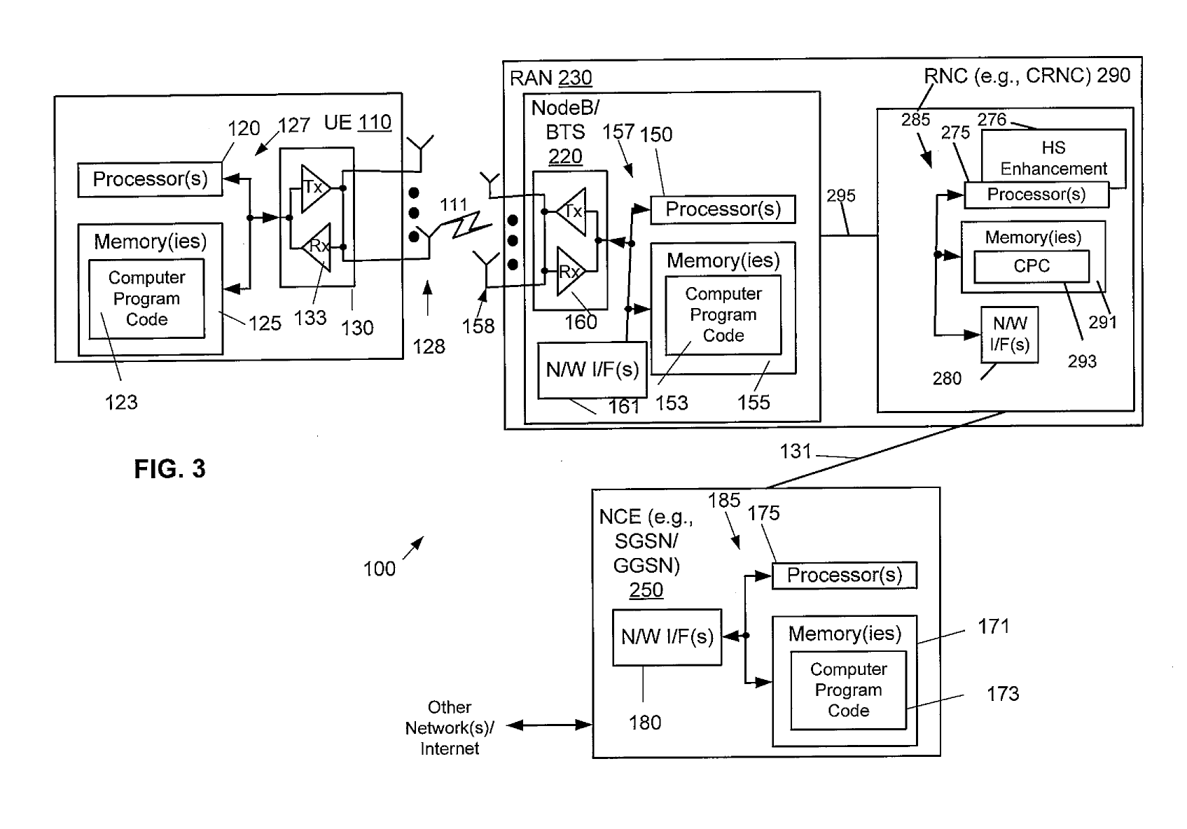

Turning to FIG. 3, this figure shows a block diagram of an exemplary system in which the exemplary embodiments may be practiced. In FIG. 3, a user equipment (UE) 110 is in wireless communication with a network 100. It is noted that UE may also be called a terminal or a user herein. The UE 110 includes one or more processors 120, one or more memories 125, and one or more transceivers 130 (comprising a transmitter, Tx, and a receiver, Rx) interconnected through one or more buses 127. The one or more transceivers 130 are connected to one or more antennas 128. The one or more memories 125 include computer program code 123. In an exemplary embodiment, the one or more memories 125 and the computer program code 123 are configured to, with the one or more processors 120, cause the user equipment 110 to perform one or more of the operations. The UE 110 communicates with the NodeB/BTS 220 in RAN 230 via link 111.

The RAN 230 includes a NodeB (e.g., a base station) 220 and an RNC 290. It is noted that the NodeB is a term used in UMTS equivalent to the BTS (base transceiver station) description used in GSM. The NodeB/BTS 220 includes one or more processors 150, one or more memories 155, one or more network interfaces (N/W I/F(s)) 161, and one or more transceivers 160 (comprising a transmitter, Tx, and a receiver, Rx) interconnected through one or more buses 157. The one or more transceivers 160 are connected to one or more antennas 158. The one or more memories 155 include computer program code 153. In an exemplary embodiment, the one or more memories 155 and the computer program code 153 are configured to, with the one or more processors 150, cause the NodeB/BTS 220 to perform one or more of the operations described herein. The one or more network interfaces 161 communicate over a network such as the network 295 used to communicate with, e.g., the RNC. The network 295 may be wired or wireless or both and may implement an interface.

The RAN 230 also includes the RNC 290. The RNC 290 includes one or more processors 275, one or more memories 291, one or more network interfaces (N/W I/F(s)) 280, interconnected through one or more buses 285. The one or more memories 291 include computer program code 293. In an exemplary embodiment, the one or more memories 291 and the computer program code 293 are configured, with the one or more processors 275, to cause the RNC 290 to perform one or more of the operations described herein. The RNC 290 includes a HS enhancement unit 276, which may be implemented in part or completely as computer program code 293 and may be executed by the one or more processors 275. The HS enhancement unit 276 may be implemented in part or completely as circuitry, e.g., in the one or more processors 275. The one or more network interfaces 280 communicate over a network such as the network 295 used to communicate with, e.g., the NodeB/BTS 220 and the network 131 used to communicate with the NCE 250. The network 131 may be wired or wireless or both and may implement an interface.

The wireless network 100 may include a network control element (NCE) 205 that may include SGSN/GGSN functionality, and which provides connectivity with a further network, such as a telephone network and/or a data communications network (e.g., the Internet). The NCE 250 includes one or more processors 175, one or more memories 171, and one or more network interfaces (N/W I/F(s)) 180, interconnected through one or more buses 185. The one or more memories 171 include computer program code 173. In an exemplary embodiment, the one or more memories 171 and the computer program code 173 are configured to, with the one or more processors 175, cause the NCE 250 to perform one or more operations.

The computer readable memories 125, 155, 171, and 291 may be of any type suitable to the local technical environment and may be implemented using any suitable data storage technology, such as semiconductor based memory devices, flash memory, magnetic memory devices and systems, optical memory devices and systems, fixed memory and removable memory. The processors 120, 150, 175, and 291 may be of any type suitable to the local technical environment, and may include one or more of general purpose computers, special purpose computers, microprocessors, digital signal processors (DSPs) and processors based on a multi-core processor architecture, as non-limiting examples.

Concerning problems with conventional systems, prior to the introduction of the high speed FACH feature, the terminal could send or receive a small amount of data in the Cell_FACH state. A parameter determines a threshold of data volume that, if not exceeded, causes the terminal to be kept in Cell_FACH state. Conversely, if the threshold is exceeded, the terminal is moved to the Cell_DCH state.

With the HS_FACH feature, as the terminal can send or receive high speed data in Cell_FACH state, the value of the threshold is increased. Without the feature, the maximum value of the threshold is typically 1024 bytes, and with the feature the maximum value in downlink can be 49,152 bytes.

The HSDPA packet data scheduler, e.g., in NodeB/BTS 220, allocates radio resources to the different terminals and data flows based on their priority. Priority of a terminal data flow is given by a Scheduling Priority Indicator (SPI), and the SPI value is determined by RNC and transferred to the NodeB. Regarding SPI, there are sixteen different SPI values from 0 (zero) to 15, where 0 (zero) indicates lowest priority, and 15 indicates the highest priority. Each terminal receiving (or transmitting) high speed data (using a high speed channel) is allocated (by RNC) an SPI value. Depending on the SPI values of the terminals for which the network is sending data, the NodeB assigns more resources to terminals with higher priority. As usually HS_FACH users have the lowest priority, these users are scheduled only if no other terminals have data transmission. Usually the traffic in the Cell_FACH state is assigned a unique priority and this is usually the lowest among the sixteen priorities.

With the new HS_FACH feature, more traffic is allowed to be carried in the Cell_FACH state, and all this traffic is treated equally. This means that there is no differentiation between the different types of traffic. As the priority of this traffic may be low, the traffic carried by terminals in the Cell_DCH state cause delay to the traffic in the Cell_FACH state.

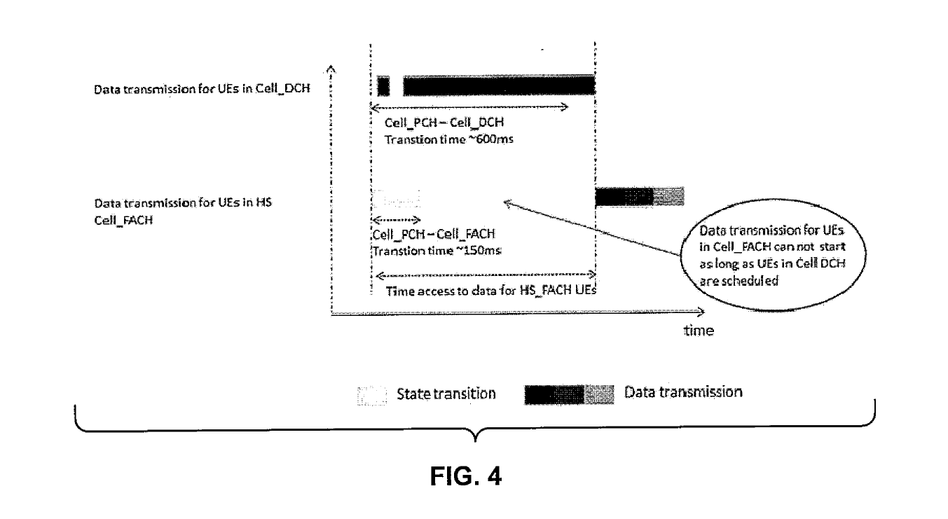

This is the cause of a bad quality of experience for the users in the Cell_FACH state. FIG. 4 illustrates this phenomenon. FIG. 4 illustrates access to data transmission for HS_FACH UEs delayed by load in the Cell_DCH state.

The problem is further described in the following scenario related to the downlink traffic.
Assume that each HS_FACH user can use 5 HSDPA codes in the downlink, and the transmit block size is then equal to 3,630 bits;
Assume the coding rate is equal to ½ and QPSK modulation is used;
Consider the data packet size for HTTP traffic to be equal to 10 kBytes and for FTP traffic equal to 100 kBytes;
Consider different numbers of HTTP, FTP and HS_FACH users;
Assume that transition from the Cell_PCH state to the Cell_DCH state takes about 600 ms (this is demonstrated by measurements) and that transition time from the cell_PCH state to the Cell_FACH state is in the range of 150 ms; and
Consider a priority based scheduler (adding fairness will alleviate the issue without solving the issue).

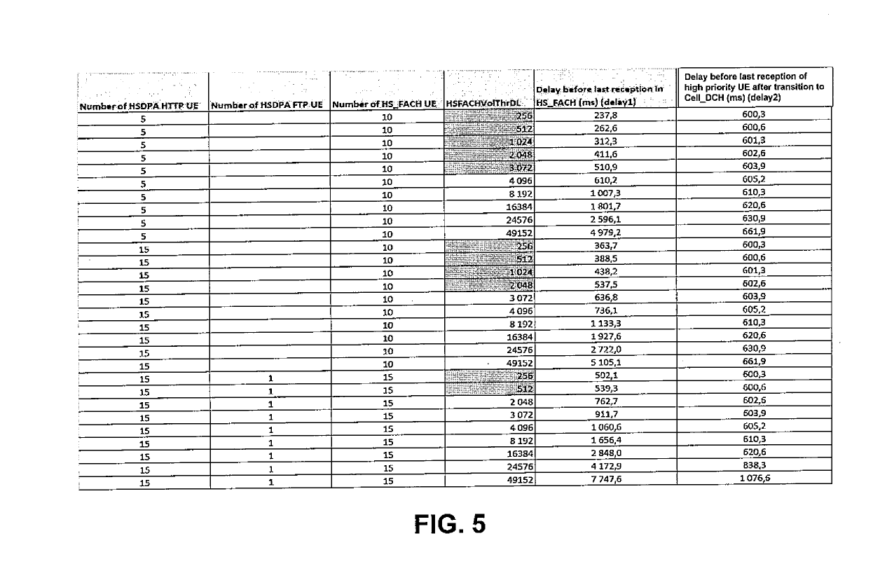

The delay for the reception of data for all users in the Cell_FACH state is calculated (delay1 in the table shown in FIG. 5). The delay is equal to the time transition from the Cell_PCH state to the Cell_FACH state to which are added 1) the time for data transmission for higher priority users (users in the Cell_DCH state) and 2) the time of data transmission of HS_HSPA users.

Then the delay is calculated for the reception of the data of one user in the Cell_PCH state if the user is moved directly to the Cell_DCH state and if the user has the highest priority (delay2 in the table of FIG. 5).

The acceptable threshold values are indicated by shading in the column entitled “HSFACHVolThrDL”. For those values, the delay of data transmission for a user moving from the Cell_PCH state to the Cell_FACH state is less than the delay of data transmission for a high priority user moving from the Cell_PCH state to the Cell_DCH state.

It can be seen from the table in FIG. 5 that depending on the load (number of users in the Cell_DCH state and in the Cell_FACH state), the value of acceptable threshold varies. Thus, in conventional systems, the only way to solve this problem is by setting a low value for the maximum allowed traffic threshold, but this would decrease the benefit of the new HS_FACH feature.

By contrast, the exemplary embodiments introduce techniques to solve this problem. The techniques are based on a dynamic adaptation of the HS_FACH feature. The exemplary embodiments are described in more detail below, after a brief introduction is presented.

As a brief introduction, in an exemplary embodiment, the transition of the Cell_PCH users to the Cell_DCH state or the Cell_FACH state is determined by a data volume threshold. The value of the threshold is adapted to the traffic load in the cell. When the traffic of users in the Cell_DCH state is high, users in the Cell_FACH state will have little chance to be scheduled and the traffic of those users will be delayed. A low value for the threshold is appropriate in this case. Meanwhile, in a cell with low traffic, the threshold is set to a high value. This will ensure that users in the Cell_FACH state experience a low delay. It is noted that what is high or low traffic depends on number of users and the data to be sent to each user, and this is illustrated in the examples below. The value of the threshold is selected so that the delay experienced by users using the HS_FACH feature in the Cell_FACH state is kept lower than the delay a high priority user would experience if the user is moved to the Cell_DCH state.

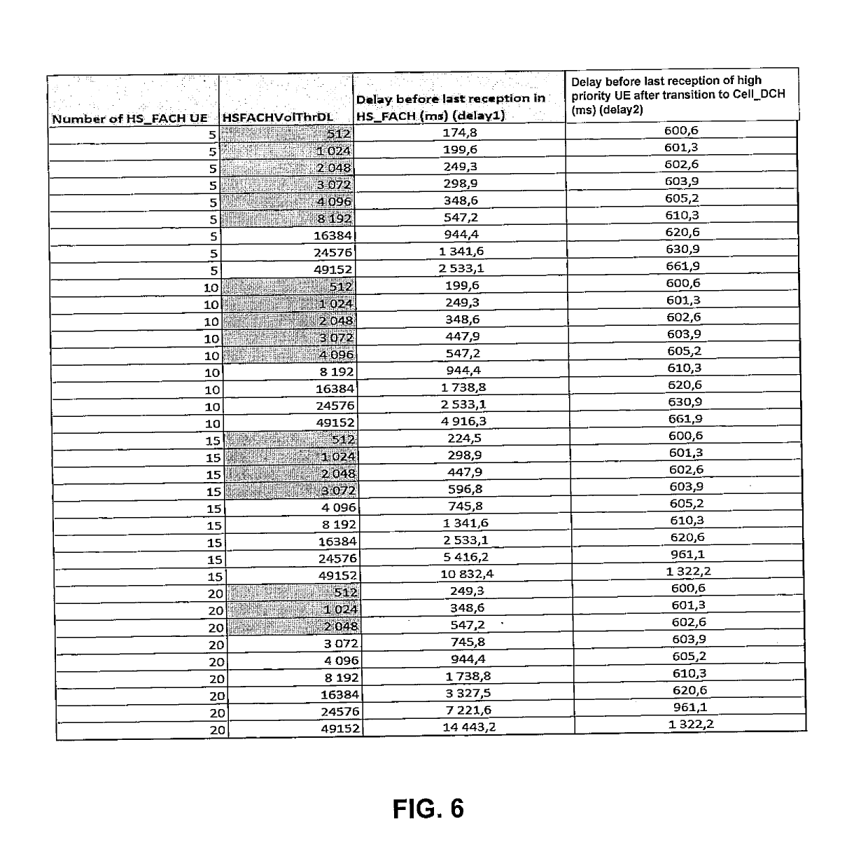

Turning to FIG. 6, this figure is a table used to illustrate how the fast access to data (e.g., low delay) is ensured for users in the Cell_FACH state due to change of the HS_FACH threshold value. To ensure fast access to data when the number of users is high, the threshold (HSFACHVolThrDL) is set to a low value. When the number of users is low, the threshold can be set to a high value. That is, when the number of HS_FACH UEs is five, the thresholds HSFACHVolThrDL of up to 8,192 may be used, as delay1 is less than delay2 for these thresholds. The UEs in the Cell_FACH state for the values of the thresholds 16,384, 24,576, and 49,152 should be transitioned from the Cell_FACH state to the Cell_DCH state, since delay1 is longer than delay2.

In more detail, the algorithm that adapts the behavior of the HS_FACH feature in the Cell_FACH state to the cell load may be based on the following. In the algorithm that follows, the RNC 290 is assumed to perform operations under control of the HS enhancement unit 275. Additionally, the functions described below may be considered to be interconnected means for performing the functions.

1) The delay of transmission of a data packet of a user moving from the Cell_PCH state to the Cell_FACH state should not take longer than if the user is moved to the Cell_DCH state. This ensures benefit from the HS_FACH feature for the fast access of UEs to data. The duration of the state transition the Cell_PCH state to the Cell_DCH state and to the Cell_FACH state can be set via parameters. The following are considered to be taken from measurement: the Cell_PCH state to the Cell_DCH state transition time is about 600 ms (PchToDchTransiTime), in some network configurations (IP transport) this delay can be lower; and the Cell_PCH state to the Cell_FACH state transition time is about 150 ms (PchToFachTransiTime).

2) HS_FACH users are allocated a unique scheduling priority indicator. Usually this is the lowest priority value.

In the following example, an algorithm is detailed for the downlink (HSDPA traffic), and similar operations can be applied to uplink traffic.

1) The RNC data buffer occupancies for all the users in the Cell_DCH state are added. In case priority of the HS_FACH users is not the lowest, the buffer occupancy of users with higher SPI only is considered. For the uplink, the traffic volume measurement reports from the UEs in the Cell_DCH state with higher SPI are added, where “higher SPI” refers to SPIs higher than HS_FACH traffic priority. This is represented by the variable TraffVolumeDch.

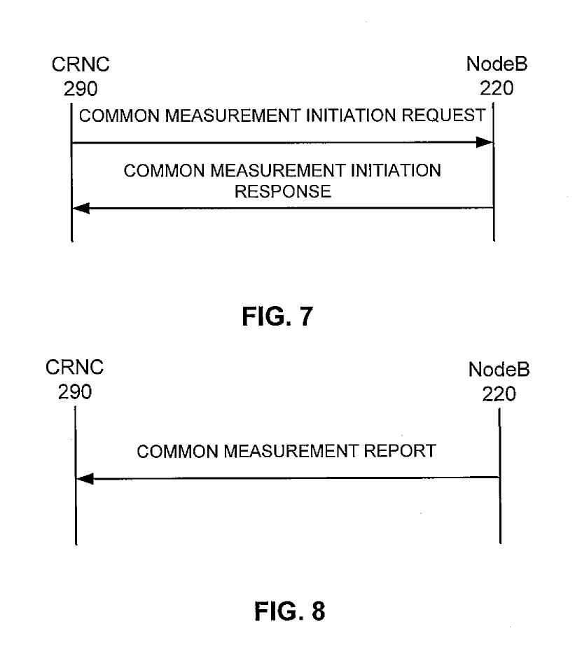

2) The RNC configures the NodeB for common measurement. FIG. 7 is a signaling diagram of a common measurement initiation procedure, successful operation, and is reproduced from 3GPP TS 25.433. The Common Measurement Type Information Element (e.g., in the Common Measurement Initiation Request”) should include “HS-DSCH Provided Bit Rate”. The Report Characteristics IE is set to “Periodic”. For the uplink, the Common Measurement Type Information Element should also include “E-DCH Provided Bit Rate”.

3) The NodeB will start reporting the Provided Bit Rate periodically. This is illustrated by FIG. 8, which is a signaling diagram of a common measurement report procedure, and is reproduced from 3GPP TS 25.433. For each priority class, the NodeB measures the total number of bits whose transmission over the radio interface has been considered successful (e.g., by MAC-hs) in Node-B during the last measurement period, divided by the duration of the measurement period. The measurement period is equal to 100 ms.

4) At each period, when a report (e.g., the common measurement report of FIG. 8) is received from NodeB, the following operations are performed:

a) Provided bit rates for the SPI, with higher priority than HS_FACH traffic priority, and reported by the NodeB 220 are added. This is represented by ProvBitRateDch. For downlink, the provided bit rates are provided using the HS-DSCH, whereas for uplink the provided bit rates are provided using the E-DCH.

b) The time required by the NodeB 220 to transmit DCH users traffic is then calculated with the formula: D_ByDch=TraffVolumeDch/ProvBitRateDch. This calculated time will delay HS_FACH users' traffic.

c) Considering now the HS_FACH users, the time duration is calculated for the NodeB to transmit traffic of all those users. Consider data packets with a size equal to the different HS_FACH thresholds, and consider the following values as an example: 128, 256, 512, 1024, 2048, 3072, 4096, 8192, 16384, 24576, and 49152. This is represented by D_ByHsFachX. For the uplink the time duration is calculated for the NodeB to receive traffic from all HS_FACH users, and the threshold values might be different.

d) For each value of the threshold, calculate the worst time duration it takes for a user moving from the Cell_PCH state to the Cell_FACH state to receive a data packet that is delayed by DCH users and other Cell_FACH user transmissions (D_HsFachDchX). This is equal to the sum of the Cell_PCH state to the Cell_FACH state transition time (PchToFachTransiTime), the delay caused by data transmission of DCH users (D_ByDch), and the transmission time of HS_FACH users of a packet with a length equal to the threshold value (D_ByHsFachX): D_HsFachDchX=PchToFachTransiTime+D_ByDch+D_ByHsFachX.

e) Calculate the time duration it takes for a high priority user moving from the Cell_PCH state to the Cell_DCH state to receive a data packet (D_TransDchX). This is also performed for each value of the threshold. This is equal to the sum of the Cell_PCH state to the Cell_DCH state transition time (PchToDchTransiTime) and the transmission time in the Cell_DCH state of a packet with a length equal to the threshold value (TransDchX): D_TransDchX=PchToDchTransiTime+TransDchX.

1) The variables D_HsFachDchX and D_TransDchX are compared, the highest value of the threshold where D_HsFachDchX is lower than D_TransDchX is considered as the threshold to be used.

g) The following parameters may be added to give flexibility to the operator in implementing the HS_FACH feature:
An Offset optionally may be added to D_HsFachDchX before performing the comparison between HS_FACH and DCH delays.
Minimum and maximum values may be added for the allowed threshold.

This gives the following formula:

MinThreshold=<

Threshold=highest value in threshold series where D_HsFachDchX+Offset is lower than D_TransDchX

=<MaxThreshold;

h) Filtering can also be added to smooth the threshold variation.

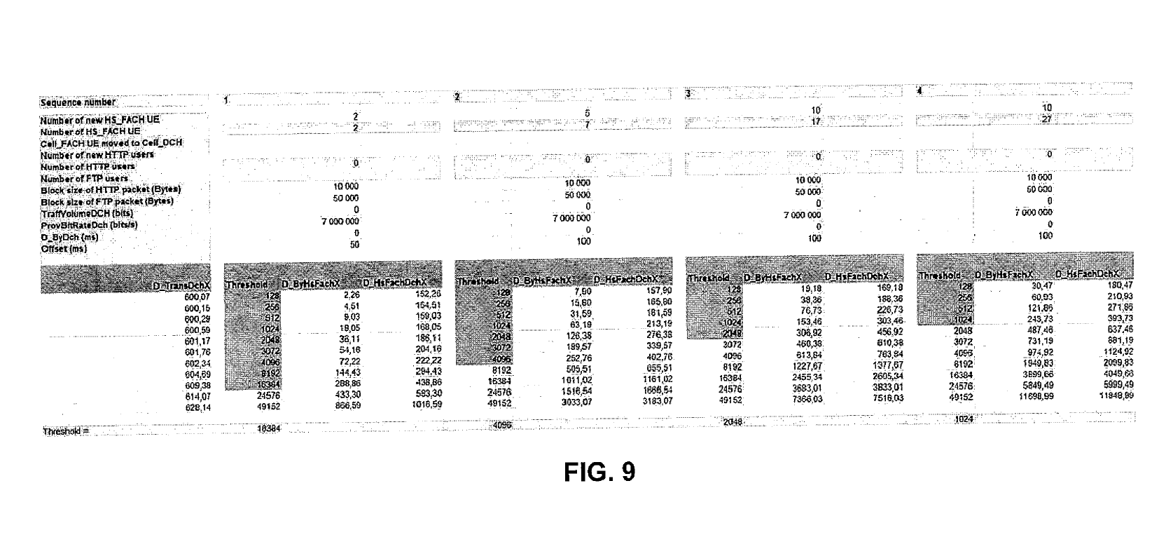

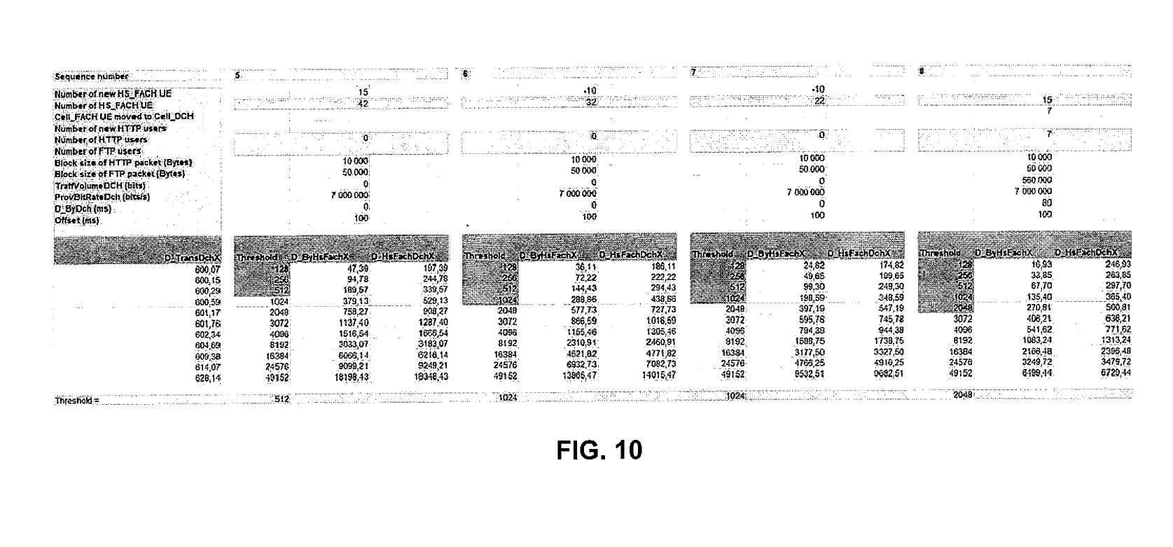

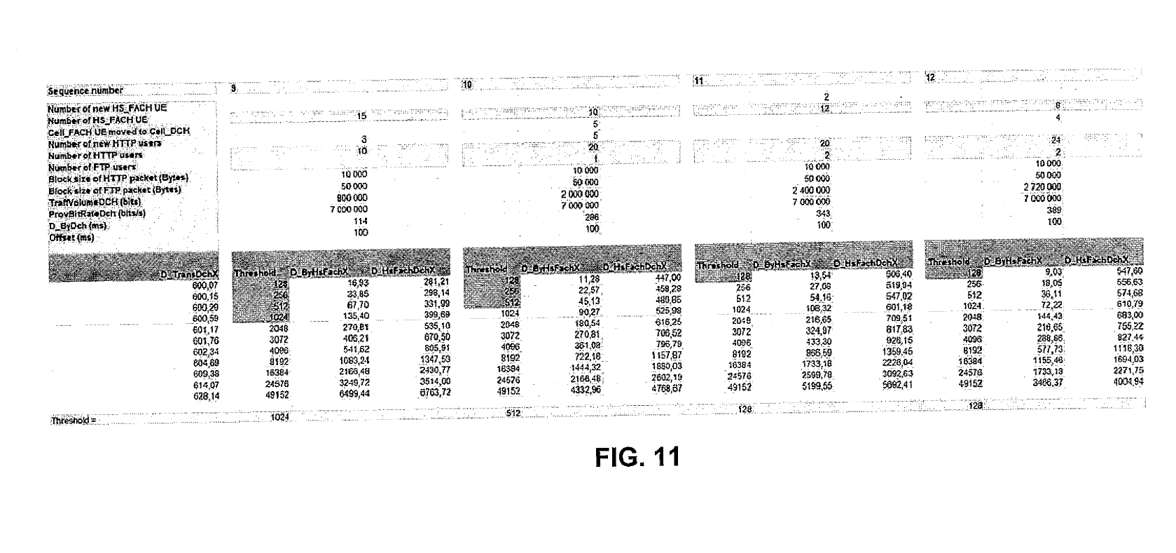

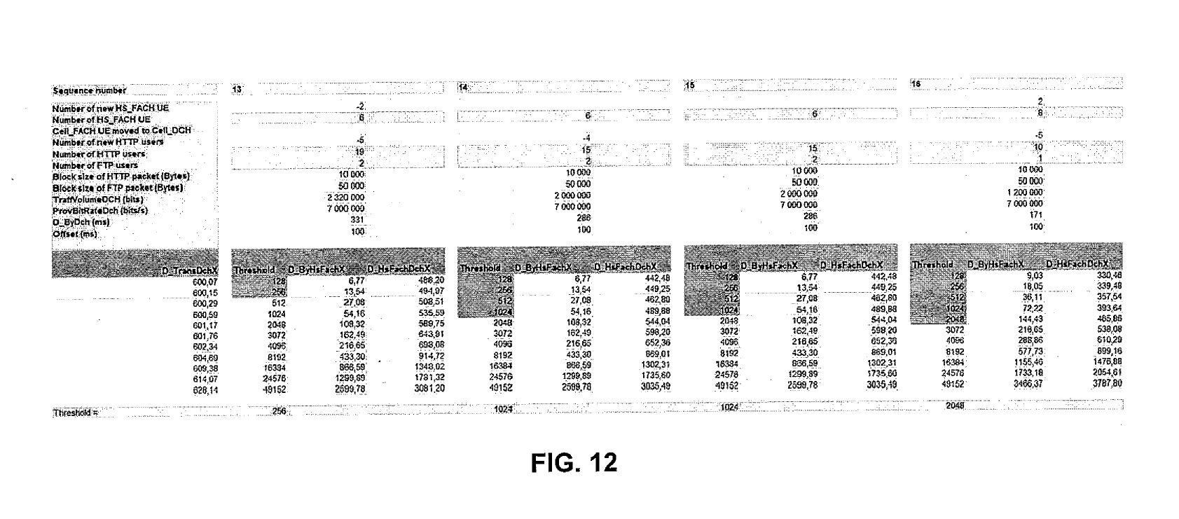

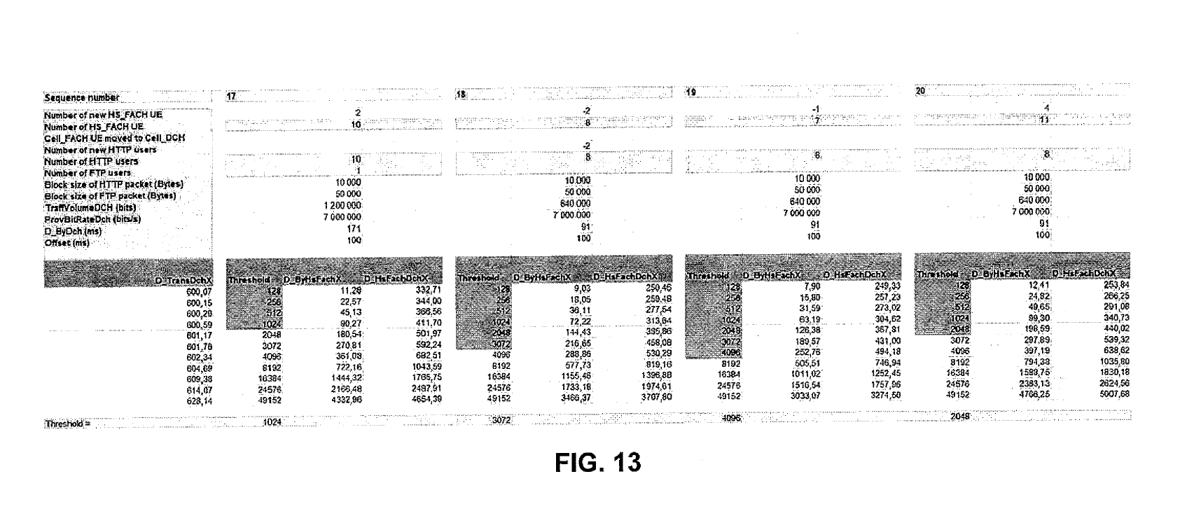

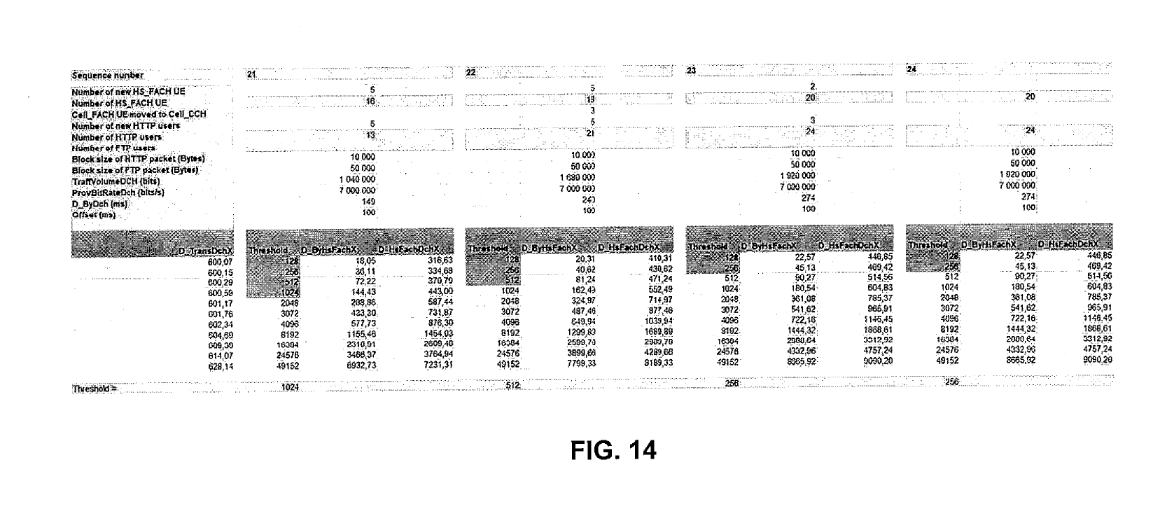

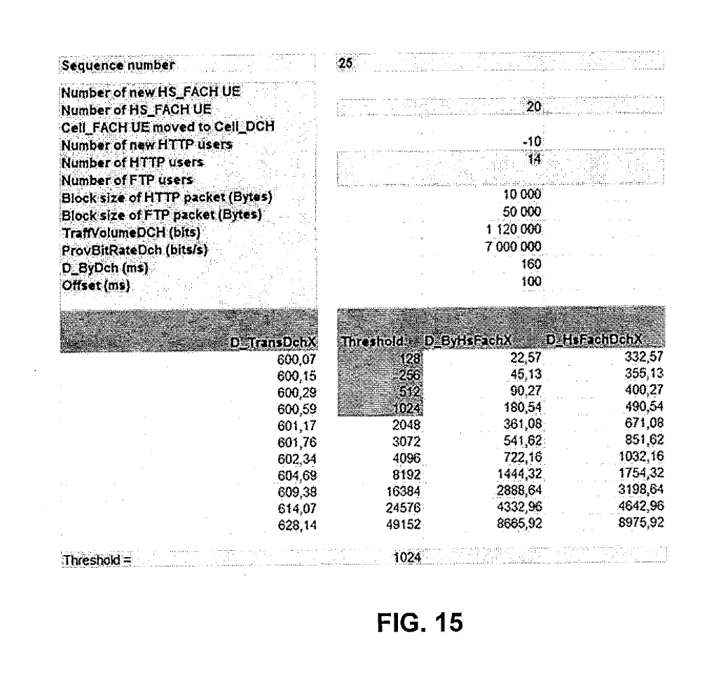

FIGS. 9-15 provide illustrations of downlink threshold change over time for downlink traffic. The sequence number represents the measurement period. Offset is set to 50 ms, minimum threshold is set to 128 Bytes. Total RLC Traffic Vol (Bits) is calculated with the number of users (e.g., FTP and HTTP). When a user is moved from the Cell_FACH state to the Cell_DCH state, the user is considered as an HTTP user. The provided bit rate is assumed to be equal to HSPA average throughput (e.g., 7 Mbits/s). The acceptable threshold values are the ones with a shaded background, highest value is the threshold to be used for the period.

For instance, reference may be made to FIG. 9, where the sequence number 1 is shown. In this sequence, there are only two users in the cell and they are in the Cell_FACH state. For the threshold of 16,384, the D_HsFachDchX is 438,86 ms (were the comma is used as a period) and the offset is 50 ms. Thus, D_HsFachDchX+Offset is 488.87 ms, which is less than D_TransDchX, which is 609,38 ms. However, for the threshold 24,576, the D_HsFachDchX is 583,30 ms and the offset is 50 ms. Thus, D_HsFachDchX+Offset is 633.30 ms, which is greater than D_TransDchX, which is 614,07 ms. The threshold chosen (as shown in the row labeled “Threshold=”) is 16,384. It can be seen from FIGS. 9-15 that different thresholds are chosen corresponding to load in a cell. In sequence number 2, there are five more users in the Cell_FACH state, making the total number of users equal to 7. In this sequence for a threshold value of 4,096, D_HsFachDchX+Offset is 452.76 ms, which is less than D_TransDchX, which is 602,34 ms, and fast access to data is ensured for those seven users in the Cell_FACH state as long as the volume of data for each user is less than 4,096 bytes.

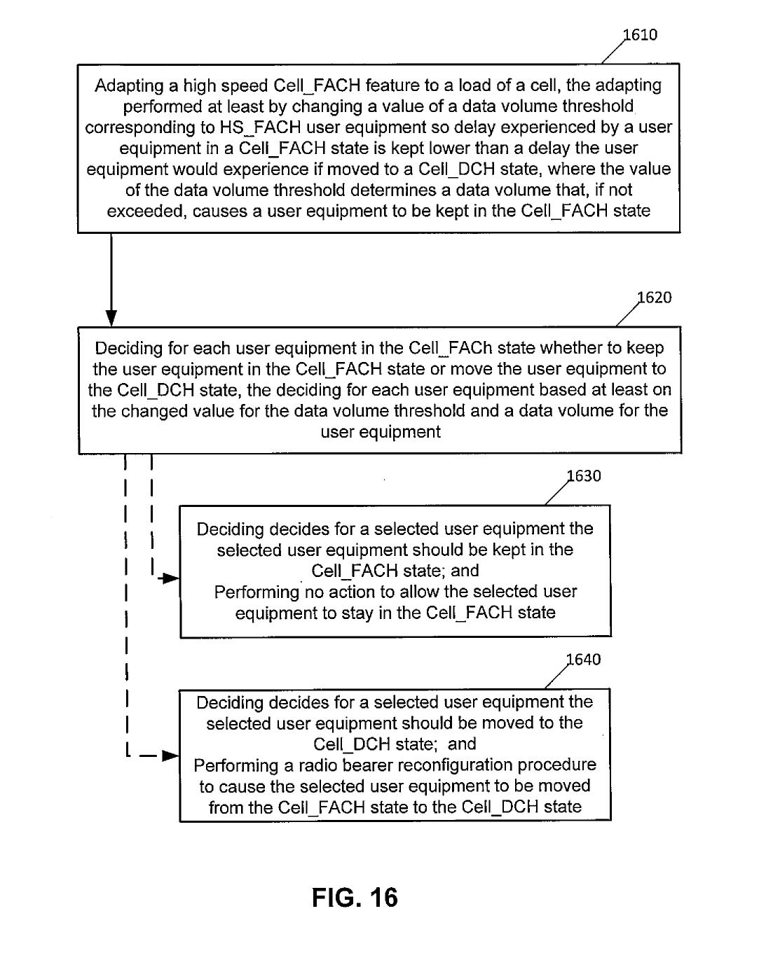

Turning to FIG. 16, this figure is a logic flow diagram for enhancement of the Implementation of the high speed cell FACH/RACH feature. This figure further illustrates the operation of an exemplary method, a result of execution of computer program instructions embodied on a computer readable memory, and/or functions performed by logic implemented in hardware, in accordance with an exemplary embodiment. The blocks in FIG. 16 may also represent interconnected means for performing the functions in the blocks.

FIG. 16 is assumed to be performed by an RNC 290, e.g., under control of the HS enhancement unit 276. In block 1610, the RNC 290 performs the operation of adapting a high speed Cell_FACH feature to a load of a cell. The adapting is performed at least by changing a value of a data volume threshold so delay experienced by a user equipment in a Cell_FACH state is kept lower than a delay the user equipment would experience if moved to a Cell_DCH state. The value of the data volume threshold determines a data volume that, if not exceeded, causes a user equipment to be kept in the Cell_FACH state. In block 1620, the RNC 290 performs the operation of deciding for each user equipment in the Cell_FACh state whether to keep the user equipment in the Cell_FACH state or move the user equipment to the Cell_DCH state. The deciding for each user equipment is based at least on the changed value for the data volume threshold and a data volume for the user equipment.

It is noted that the RNC 290 may, for the deciding, also perform the operation of (block 1630) deciding for a selected user equipment the selected user equipment should be kept in the Cell_FACH state. The RNC 290 may therefore perform the operation of performing no action regarding the state of the user equipment to allow the selected user equipment to stay in the Cell_FACH state. In this case data transmission for this user equipment takes place in Cell_FACH state.

The RNC 290 may also perform, for the deciding, the operation of (block 1640) deciding for a selected user equipment the selected user equipment should be moved to the Cell_DCH state. The RNC 290 may therefore perform a radio bearer reconfiguration procedure to cause the selected user equipment to be moved from the Cell_FACH state to the Cell_DCH state. For instance, the packet scheduler (in the RNC 290) may request the RRC signaling entity of the RNC to start the radio bearer reconfiguration procedure. The RRC signaling entity sends an RRC: RADIO BEARER RECONFIGURATION message to the UE on the forward access channel (FACE), which is acknowledged with an RRC: RADIO BEARER RECONFIGURATION COMPLETE message on a dedicated channel (DCH) after synchronization and L2 configuration. After the procedure, the UE is in CELL_DCH state and data transmission on dedicated channel can begin.

Additional exemplary embodiments include the following. A method as in any of the above, wherein changing the value further comprises: calculating, for each value of the threshold in a threshold series, a worst time duration it takes for a user equipment moving from the Cell_PCH state to the Cell_FACH state to receive or send a data packet that is delayed by DCH users and other Cell_FACH user transmissions; calculating, for each value of the threshold in the threshold series, a second time duration it takes for a user equipment moving from the Cell_PCH state to the Cell_DCH state to receive or send a data packet; comparing, for each value of the threshold in the threshold series, the worst time duration and the second time duration to determine a highest value of the threshold in the threshold series meeting a criterion; and changing the value of the threshold to the highest value of the threshold.

A method as in the previous paragraph, wherein comparing further comprises setting the threshold using the following equation: Threshold=highest value in the threshold series where D_HsFachDchX is lower than D_TransDchX, where Threshold is a calculated value of the threshold, D_HsFachDchX is a calculation of the worst time duration it takes for a user moving from the Cell_PCH state to the Cell_FACH state to receive a data packet that is delayed by DCH users and other Cell_FACH user transmissions, and D_TransDchX is a calculation of the time duration it takes for user moving from the Cell_PCH state to the Cell_DCH state to receive a data packet.

A method as in the previous paragraph, wherein the equation is as follows: Threshold=highest value in the threshold series where D_HsFachDchX+Offset is lower than D_TransDchX, where Offset is a given offset added to D_HsFachDchX.

A method as in the two previous paragraphs, wherein D_HsFachDchX is determined by summing a Cell_PCH state to a Cell_FACH state transition time, a delay caused by data transmission of DCH users, and a transmission time of HS_FACH users of a packet with a length equal to the threshold value.

A method as in the previous paragraph, wherein the method is performed for uplink and the delay caused by data transmission of DCH users, D_ByDch, is calculated by the following equation: D_ByDch=TraffVolumeDch/ProvBitRateDch, where TraffVolumeDCH is determined by adding traffic volume measurement reports from the user equipment in the Cell_DCH state with scheduling priority indicators with higher priority than HS_FACH traffic priority, and ProvBitRateDch is determined by adding enhanced dedicated channel provided bit rates for scheduling priority indicators with higher priority than HS_FACH traffic priority.

A method as in two paragraphs above, wherein the method is performed for downlink and the delay caused by data transmission of DCH users, D_ByDch, is calculated by the following equation: D_ByDch=TraffVolumeDch/ProvBitRateDch, where TraffVolumeDCH is determined by adding data buffer occupancy of user equipment with scheduling priority indicators with higher priority than HS_FACH traffic priority, and ProvBitRateDch is determined by adding high speed-downlink shared channel provided bit rates for scheduling priority indicators with higher priority than HS_FACH traffic priority.

A method as above, wherein D_TransDchX is determined by summing a Cell_PCH state to a Cell_DCH state transition time and a transmission time in a Cell_DCH state of a packet with a length equal to the threshold value.

A method as above, wherein the threshold is associated with a minimum value and changing comprises changing the value of the threshold to the minimum value in response to the Threshold having a value less than the minimum value.

A method as above, wherein the threshold is associated with a maximum value and changing comprises changing the value of the threshold to the maximum value of the threshold in response to the Threshold having a value greater than the maximum value.

A method as above, wherein the adapting and causing are performed in response to a measurement report being received from a base station of a provided bit rate. A method as in this paragraph, wherein the provided bit rate indicates a total number of bits whose transmission over a radio interface has been considered successful. A method as in this paragraph, further comprising configuring the base station for common measurement so that the base station periodically sends the measurement report.

A method as above, performed by a radio network controller in at least one of a wideband code division multiple access or a high speed packet access system.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 3. A computer-readable medium may comprise a computer-readable storage medium (e.g., memories 125, 155, 171, 291 or other device) that does not encompass propagating signals but may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects are set out above, other aspects comprise other combinations of features from the described embodiments, and not solely the combinations described above.

It is also noted herein that while the above describes example embodiments of the invention, these descriptions should not be viewed in a limiting sense. Rather, there are several variations and modifications which may be made without departing from the scope of the present invention.

The following abbreviations that may be found in the specification and/or the drawing figures are defined as follows:

3GPP third generation partnership project

BTS Base Transceiver Station

CPC Computer Program Code

CRNC Controlling Radio Network Controller

DCH Dedicated CHannel

DL Downlink (from base station to UE)

E-DCH Enhanced-DCH

FTP File Transfer Protocol

FACH Forward Access CHannel

GGSN gateway GPRS support node

GPRS General Packet Radio Service

GSM Global System for Mobile Communications

HSDPA High Speed Downlink Packet Access

HS-DSCH High Speed-Downlink Shared CHannel

HSPA High Speed Packet Access

HTTP HyperText Transmission Protocol

IP Internet Protocol

kBytes kilobytes

MAC-hs Media Access Control-high speed

Mbits/s Megabits per second

ins milliseconds

NCE Network Control Element

NodeB a base station

QPSK Quadrature Phase Shift Keying

RACH Random Access CHannel

RAN Radio Access Network

Rel Release

RNC Radio Network Controller

Rx Receiver

SGSN serving GPRS support node

SPI Scheduling Priority Indicator

Tx Transmitter

UE User Equipment

UL Uplink (from UE to base station)

UMTS Universal Mobile Telecommunications System

WCDMA Wideband Code Division Multiple Access

1. A method, comprising:
adapting a high speed Cell_FACH feature to a load of a cell, the adapting performed at least by changing a value of a data volume threshold corresponding to HS_FACH user equipment so delay experienced by a user equipment in a Cell_FACH state is kept lower than a delay the user equipment would experience if moved to a Cell_DCH state, where the value of the data volume threshold determines a data volume that, if not exceeded, causes a user equipment to be kept in the Cell_FACH state; and
deciding for each user equipment in the Cell_FACh state whether to keep the user equipment in the Cell_FACH state or move the user equipment to the Cell_DCH state, the deciding for each user equipment based at least on the changed value for the data volume threshold and a data volume for the user equipment.

2. The method of claim 1, wherein:
deciding decides for a selected user equipment the selected user equipment should be kept in the Cell_FACH state; and
the method further comprises performing no action regarding the state of the user equipment to allow the selected user equipment to stay in the Cell_FACH state.

3. The method of claim 1, wherein:
deciding decides for a selected user equipment the selected user equipment should be moved to the Cell_DCH state; and
the method further comprises performing a radio bearer reconfiguration procedure to cause the selected user equipment to be moved from the Cell_FACH state to the Cell_DCH state.

4. The method of claim 1, wherein changing the value further comprises:
calculating, for each value of the threshold in a threshold series, a worst time duration it takes for a user equipment moving from the Cell_PCH state to the Cell_FACH state to receive or send a data packet that is delayed by DCH users and other Cell_FACH user transmissions;
calculating, for each value of the threshold in the threshold series, a second time duration it takes for a user equipment moving from the Cell_PCH state to the Cell_DCH state to receive or send a data packet;
comparing, for each value of the threshold in the threshold series, the worst time duration and the second time duration to determine a highest value of the threshold in the threshold series meeting a criterion; and
changing the value of the threshold to the highest value of the threshold.

5. The method of claim 4, wherein comparing further comprises setting the threshold using the following equation:
Threshold=highest value in the threshold series where D_HsFachDchX is lower than D_TransDchX,
where Threshold is a calculated value of the threshold, D_HsFachDchX is a calculation of the worst time duration it takes for a user moving from the Cell_PCH state to the Cell_FACH state to receive a data packet that is delayed by DCH users and other Cell_FACH user transmissions, and D_TransDchX is a calculation of the time duration it takes for user moving from the Cell_PCH state to the Cell_DCH state to receive a data packet.

6. The method of claim 5, wherein the equation is as follows:
Threshold=highest value in the threshold series where D_HsFachDchX+Offset is lower than D_TransDchX,
where Offset is a given offset added to D_HsFachDchX.

7. The method of claim 5, wherein D_HsFachDchX is determined by summing a Cell_PCH state to a Cell_FACH state transition time, a delay caused by data transmission of DCH users, and a transmission time of HS_FACH users of a packet with a length equal to the threshold value.

8. The method of claim 7, wherein the method is performed for uplink and the delay caused by data transmission of DCH users, D_ByDch, is calculated by the following equation:
D_ByDch=TraffVolumeDch/ProvBitRateDch,
where TraffVolumeDCH is determined by adding traffic volume measurement reports from the user equipment in the Cell_DCH state with scheduling priority indicators with higher priority than HS_FACH traffic priority, and ProvBitRateDch is determined by adding enhanced dedicated channel provided bit rates for scheduling priority indicators with higher priority than HS_FACH traffic priority.

9. The method of claim 7, wherein the method is performed for downlink and the delay caused by data transmission of DCH users, D_ByDch, is calculated by the following equation:
D_ByDch=TraffVolumeDch/ProvBitRateDch,
where TraffVolumeDCH is determined by adding data buffer occupancy of user equipment with scheduling priority indicators with higher priority than HS_FACH traffic priority, and ProvBitRateDch is determined by adding high speed-downlink shared channel provided bit rates for scheduling priority indicators with higher priority than HS_FACH traffic priority.

10. The method of claim 5, wherein D_TransDchX is determined by summing a Cell_PCH state to a Cell_DCH state transition time and a transmission time in a Cell_DCH state of a packet with a length equal to the threshold value.

11. The method of claim 5, wherein the threshold is associated with a minimum value and changing comprises changing the value of the threshold to the minimum value in response to the Threshold having a value less than the minimum value.

12. The method of claim 5, wherein the threshold is associated with a maximum value and changing comprises changing the value of the threshold to the maximum value of the threshold in response to the Threshold having a value greater than the maximum value.

13. The method of claim 1, wherein the adapting and causing are performed in response to a measurement report being received from a base station of a provided bit rate.

14. The method of claim 13, wherein the provided bit rate indicates a total number of bits whose transmission over a radio interface has been considered successful.

15. The method of claim 13, further comprising configuring the base station for common measurement so that the base station periodically sends the measurement report.

16. The method of claim 1, performed by a radio network controller in at least one of a wideband code division multiple access or a high speed packet access system.

17. An apparatus, comprising:
one or more processors; and
one or more memories including computer program code,
the one or more memories and the computer program code configured, with the one or more processors, to cause the apparatus to perform at least the following:
adapting a high speed Cell_FACH feature to a load of a cell, the adapting performed at least by changing a value of a data volume threshold corresponding to HS_FACH user equipment so delay experienced by a user equipment in a Cell_FACH state is kept lower than a delay the user equipment would experience if moved to a Cell_DCH state, where the value of the data volume threshold determines a data volume that, if not exceeded, causes a user equipment to be kept in the Cell_FACH state; and
deciding for each user equipment in the Cell_FACh state whether to keep the user equipment in the Cell_FACH state or move the user equipment to the Cell_DCH state, the deciding for each user equipment based at least on the changed value for the data volume threshold and a data volume for the user equipment.

18. A computer program product comprising a computer-readable storage medium bearing computer program code embodied therein for use with a computer, the computer program code comprising:
code for adapting a high speed Cell_FACH feature to a load of a cell, the adapting performed at least by changing a value of a data volume threshold corresponding to HS_FACH user equipment so delay experienced by a user equipment in a Cell_FACH state is kept lower than a delay the user equipment would experience if moved to a Cell_DCH state, where the value of the data volume threshold determines a data volume that, if not exceeded, causes a user equipment to be kept in the Cell_FACH state; and
code for deciding for each user equipment in the Cell_FACh state whether to keep the user equipment in the Cell_FACH state or move the user equipment to the Cell_DCH state, the deciding for each user equipment based at least on the changed value for the data volume threshold and a data volume for the user equipment.
